(19) United States
(12) Patent Application Publication
(10) Pub. No.: US 2013/0042466 A1
(43) Pub. Date: Feb. 21, 2013

(54) Method for improving the properties of NiMH batteries

(71) Applicant: Aishen Wu, Foshan (CN)

(72) Inventor: Aishen Wu, Foshan (CN)

(73) Assignee: Shida Battery Technology Co., LTD., Foshan (CN)

(21) Appl. No.: 13/507,384

(22) Filed: Jan. 6, 2010

(51) Int. Cl. H01M 10/00

(52) U.S. Cl. 29/623.2

(57) ABSTRACT

The invention concerns a method of improving the properties of a rechargeable nickel metal hydride battery. The method comprises a step of adding hydrogen peroxide in the alkaline electrolyte right before the closing of a sealed battery. Better performances on positive electrode active material utilization, charge retention at high temperature, and cycle stability are realized through this invention.

### FIELD OF THE INVENTION

The present invention concerns a method for improving the properties of rechargeable nickel metal hydride batteries by adding a hydrogen peroxide treatment before closing the seal cells.

### BACKGROUND OF THE INVENTION

Nickel metal hydride batteries are widely used in consumer electronics which include portable computers, cellular phones and new cordless appliances. It also has a bright prospect for being utilized as, a high performance battery for electrical vehicles, hybrid electric vehicles, and plug-in hybrid electric vehicles because of its relatively inexpensive cost, abuse tolerance, high rate capability, long cycle life and environment friendly properties.

In the design of nickel metal hydride, it is important to keep the capacities from negative electrode and positive electrode under well balance as disclosed in Fetcenko, U.S. Pat. No. 6,593,024B2. Methods such as hot alkaline treatment of powder or electrode are disclosed in Reichman, U.S. Pat. No. 4,716,088 and Lee, U.S. Pat. No. 5,874,824 to engineer the cell balance before closing the cell. However, these methods require extensive chemical processes dealing with high flammable metal powder. Therefore, an easy and inexpensive process is highly desirable to engineer the cell balance during the battery fabrication.

Potassium hydroxide solution is the most commonly used electrolyte in the alkaline rechargeable batteries (Ikoma, U.S. Pat. No. 4,935,318, Hong, U.S. Pat. No. 5501917, Mori, No. U.S. Pat. No. 5,393,616). Sodium hydroxide (Adams, U.S. Pat. No. 4,180,623, Lian, U.S. Pat. No. 5,830,601) and lithium hydroxide (Zhang, U.S. Pat. No. 5,242,656, Bernard, U.S. Pat. No. 6,156,454) are the two most commonly used additives in the electrolyte to improve the low temperature, charge retention, and high power performance. Other alkaline hydroxides, such as RbOH and CsOH (Arisawa, U.S. Pat. No. 6,605,384B2), fluoride, phosphate, and borates (Phillips, U.S. Pat. No. 7,550,230B2) were also tried as the additives to the electrolyte. Besides, reducing agents such as NaBH₄ and KBH₄ were used before to improve the cell balance in the alkaline (Magahed, U.S. Pat. No. 4,397,925). But none of the oxidation agent has been applied in the electrolyte in alkaline rechargeable battery before.

Hydrogen peroxide is an inexpensive oxidation agent but it is very unstable and prompt to immediately decomposition in an alkaline environment with a stabilizer as disclosed in Wang, U.S. Pat. No. 7,169,237B2). The only prior example was to use a H₂O₂ wash followed by a sequence of alkaline solution treatment and boric acid immersion bath on a negative electrode belt for nickel cadmium battery (Woidt, U.S. Pat. No. 4,713,126). The process itself is very complicate and not cost-effective. The such-obtained electrode is unstable and highly flammable, which is not suitable for mass production.

### SUMMARY OF THE INVENTION

In brief the method of improving the properties includes adding a hydrogen peroxide reaction before the closing of the cell. Part of the metallic contents of the battery components will be oxidized and the evolved hydrogen gas as the reaction product has the opportunity to leave the cell without causing the cell imbalance which will increase the cell pressure and hinder the charge retention and cycle life properties of nickel metal hydride battery.

### BRIEF DESCRIPTION OF THE DRAWINGS

FIG. 1 is a graph showing the improvement in the positive electrode active material utilization rate in mAh/g as a function of amount of hydrogen peroxide added in the electrolyte of nickel metal hydride battery made from both AB5 and A2B7 hydrogen storage alloys.

### DETAILED DESCRIPTION OF THE INVENTION

During the cycling of nickel metal hydride battery, some metallic components will go through the oxidation process in the strong alkaline electrolyte environment. These metals include negative electrode active material, positive electrode additives such as cobalt metal and cobalt monoxide, electrode supporting materials (foam, mesh, or expanded metal), interconnect hardware, and can. Even the separator made from nonwoven fabric will undergo such oxidation during the service life. The oxidation requires the availability of oxygen atom, which is from the water content in the electrolyte. As metal oxides in water, hydrogen gas is generated as:

M+xH₂O→MOₓ+xH₂

The such-generated hydrogen is absorbed back in the negative electrode active material, which is a hydrogen storage alloy. In a positive electrode limited design, the extra capacity (charged part of the negative electrode) becomes the over-discharge reservoir and reduces the amount of over-charge reservoir according to the calculation:

Negative electrode capacity=Over-discharge reservoir+positive electrode capacity+Over-charge reservoir

The reduction in over-charge reservoir increases the cell pressure at the final stage of a full charge and increases the probability of venting gas from the sealed cell. Metal oxidation and/or venting consume the electrolyte. As the amount of electrolyte reduces, the cell inner resistance increases and the degradation in capacity and power deteriorate.

One way to reduce the metal oxidation during cycle life is to perform an oxidation before the cell is closed and therefore the generated hydrogen gas can easily vent out. However, the conventional methods of pre-oxidizing negative electrode or powder in a hot alkaline and/or precharge (pre-oxidation) of positive electrode active material (Ni(OH)₂) and/or the cobalt additives (Co, CoO or Co(OH)₂) are very costly, dangerous, and complicated. The current invention is to add some amount of hydrogen peroxide, which is know to be an excellent oxidation agent, right before the cell is closed. This process is very simple and easy to control. The amount of oxidation can be controlled by the amount of hydrogen peroxide added. The hydrogen gas generated from the cell can be easier vented out. The heat generated is minor and do not require extra cooling.

After the battery is partially oxidized by the hydrogen peroxide before the cell close, less oxidation will occur during the process of life cycling. Therefore, cycle life can be extended until oxidation accumulates to a venting level.

The pre-oxidation of positive active material and/or cobalt additive by hydrogen peroxide also has an advantage over the conventional oxidation (charging) by electrical current. This pre-oxidation happens without the assistance of electrical current and can be anywhere in the can, which is different from the electrical oxidation (charging) that only the portion of the electrode that :has the shortest distance or least resistance to the current collector will be charged first. Before the Co-conductive network is established, the charging (oxidation) in the positive electrode is very non-uniform and this is the reason why very small charge current is used in the formation cycle. The oxidation through the current invention does not differentiate area with better conduction paths to the current collector to area without and therefore is very important to increase the utilization rate of positive electrode.

### EXAMPLE 1

60 AAA-size batteries were fabricated from wet paste negative electrode using the commercial available AB5 powder with a composition MmNi3.52Co0.73Mn0.36A10.3 as the active ingredient with HPMC/PTFE as binder, wet paste positive electrode using the commercial available Ni58.5±3%, Co1.5±0.5% , Zn3.5±0.7% spherical powder with CMC/PTFE as binder material on Ni foam. The separator is made from commercial available grafted PP/PE. After filling each battery with 1.2 gram of 30% KOH (additional materials: 2%-5% NaOH and 1%-2% LiOH) electrolyte, 15 cells were closed immediately (A1), 15 cells were adding with 1 drop of 30 wt. % hydrogen peroxide solution (average weight of 17.6 mg) (A2), the concentration of hydrogen peroxide in the electrolyte of A2 is about 0.44 wt. %. After sitting for 120 minutes, the cells were closed. Same procedures were applied to the other two groups of 15 cells each by adding two (A3) and three (A4) drops of 30 wt. % hydrogen peroxide solution. The concentrations of hydrogen peroxide in the electrolyte of A3 and A4 are about 0.88 and 1.32 wt. %, respectively.

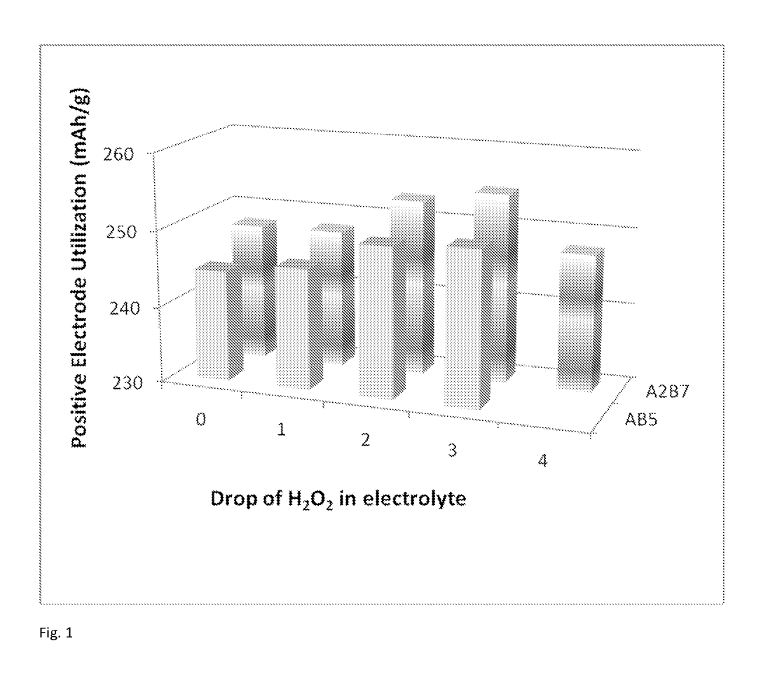

All 60 cells were first charged with a 0.1 C rate for 3 hours and then stored at 45±5° C. for 24 hours, followed by cooling in room temperature for more than 6 hours. The cells were then charged with a 0.1 C rate for 7 hours; discharged with a 0.2 C rate to 1.0 volt; charged with a 0.2 C rate for 10 hours; discharged with a 0.2 C rate to 1.0 volt; charge with a 0.1 C rate for 12 hours; discharged with a 1 C rate to 1.0 volt and then a pull at 0.2 C to 1.0 volt; finally a 0.1 C charge for 16 hours with a 1 C rate discharge to 1.0 volt. The such-obtained cell capacity combining with the weight of positive electrode active material was used to the capacity density and listed in Table 1 and plotted in FIG. 1. From now on, all data reported here is from the average of the information of individual cells from the same group. It is obvious that with the increase in the hydrogen peroxide amount, the capacity per unit positive electrode active material increases. The weight loss during cell formation, which is an indication of slightly venting of the cell, completely goes down to noise level with the addition of hydrogen peroxide. The inner pressure of battery during pressure can be effectively controlled by the addition of hydrogen peroxide in the electrolyte. The average internal resistances from each group before cycling are very similar (17.4 to 18.0 mΩ).

The high temperature charge retention experiment was performed by starting 5 to 8 cells at full charged state (1 C rate charge for 66 minutes) and kept at 60° C. for 28 days. The cells were removed from the oven and stayed in room temperature for more than 2 hours. The cell voltage and resistance were measured at this time and followed by a capacity measurement at 1 C to 1.0 volt. The resistance drift was calculated by comparing the internal resistance before and after the high temperature storage experiment and listed in Table 1. A3 with 2 drops of hydrogen peroxide shows the smallest average resistance drift. The charge retention percentage was calculated by dividing the 1 C capacity after 60° C. storage by the original 1 C capacity. The results are listed in Table 1 and show clear advantage of higher hydrogen peroxide concentration to increases the charge retention.

The cycle life experiment was performed by taking one cell from each group after measuring the capacity and cycling with the following condition for 300 times: charge at 1 C rate for 72 minutes or −ΔV=5 my depending which condition happened first; 1 C discharge to 1.0 volt. The capacity degradation, internal resistance, and mid-point voltage were measured and listed in Table 1. From the data, it is clear to see the advantage of adding 3 drops of hydrogen peroxide in reducing the cycle degradation both in capacity and internal resistance. The mid-point voltage after cycling also increases with the amount of hydrogen peroxide and is an indication of improvement in high power performance.

### EXAMPLE 2

75 AAA-size batteries were fabricated from wet paste negative electrode using the A2B7 powder with an average chemical composition Nd_{18.8}Mg_{2.5}Ni_{65.0}A_{13.6} as the active ingredient with HPMC/PTFE as binder, wet paste positive electrode using the commercial available Ni58.5±3%, Co1.5±0.5%, Zn3.5±0.7% spherical powder with CMC/PTFE as binder material on Ni foam. The separator is made from commercial available grafted PP/PE. After filling each battery with 1.2 gram of 30% KOH (additional material: 2%-5% NaOH and 1%-2% LiOH) electrolyte, 15 cells were closed immediately (B1), 15 cells were adding with 1 drop of 30 wt. % hydrogen peroxide solution (average weight of 17.6 mg) (B2), the concentration of hydrogen peroxide in the electrolyte of B2 is about 0.44 wt. %. After sitting for 120 minutes, the cells were closed. Same procedures were applied to the other three groups of 15 cells each by adding two (B3), three (B4), four (B5) drops of 30 wt. % hydrogen peroxide solution. The concentrations of hydrogen peroxide in the electrolyte of B3, B4 and B5 are about 0.88, 1.32 and 1.76 wt. %, respectively.

All 75 cells were first charged with a 0.1 C rate for 3 hours and then stored at 45±5° C. for 24 hours, followed by cooling in room temperature for more than 6 hours. The cells were then charged with a 0.1 C rate for 7 hours; discharged with a 0.2 C rate to 1.0 volt; charged with a 0.2 C rate for 10 hours; discharged with a 0.2 C rate to 1.0 volt; charge with a 0.1 C rate for 12 hours; discharged with a 1 C rate to 1.0 volt and then a pull at 0.2 C to 1.0 volt; finally a 0.1 C charge for 16 hours with a 1 C rate discharge to 1.0 volt. The such-obtained cell capacity combining with the weight of positive electrode active material was used to the capacity density and listed in Table 2 and plotted in FIG. 1. From now on, all data reported here is from the average of the information of individual cells from the same group. It is obvious that with the increase in the hydrogen peroxide amount, the capacity per unit positive electrode active material increases. The weight loss during cell formation, which is an indication of slightly venting of the cell, completely goes down to noise level with the addition of hydrogen peroxide. The inner pressure of battery during pressure can be effectively controlled by the addition of hydrogen peroxide in the electrolyte. The average internal resistances from each group before cycling increases from 16.5 to 17.4 and then reduce to 16.1 mΩ with the increase in hydrogen peroxide concentration.

The high temperature charge retention experiment was performed by starting 5 to 8 cells at full charged state (1 C rate charge for 66 minutes) and kept at 60° C. for 28 days. The cells were removed from the oven and stayed in room temperature for more than 2 hours. The cell voltage and resistance were measured at this time and followed by a capacity measurement at 1 C to 1.0 volt. The resistance drift was calculated by comparing the internal resistance before and after the high temperature storage experiment and listed in Table 2. The resistance drift reduces with the increase in hydrogen peroxide. B4 with 3 drops of hydrogen peroxide shows the smallest average resistance drift. Adding more hydrogen peroxide (B5) causes large increase in the resistance. The charge retention percentage was calculated by dividing the 1 C capacity after 60° C. storage by the original 1 C capacity. The results are listed in Table 2 and show clear advantage of higher hydrogen peroxide concentration to increases the charge retention up to B4. At higher hydrogen peroxide concentration, the charge retention properties are deteriorated.

The cycle life experiment was performed by taking one cell from each group after measuring the capacity and cycling with the following condition for 300 times: charge at 1 C rate for 72 minutes or −ΔV=5 my depending which condition happened first; 1 C discharge to 1.0 volt. The capacity degradation, internal resistance, and mid-point voltage were measured and listed in Table 2. There is almost no effect of hydrogen peroxide to A2B7 alloy in the room temperature cycling before too much hydrogen peroxide was added (B5). The mid-point voltage after cycling increased in the beginning with the amount of hydrogen peroxide and then reduced. The highest mid-point voltage was obtained with B3 (2 drops of hydrogen peroxide).

TABLE 1
Sealed cell performance comparing control (A1) and cells with
H₂O₂ added (A2-A4) from AB5 alloy.

| | A1 | A2 | A3 | A4 |
|---|---|---|---|---|
| H₂O₂ amount | 0 | 1 drop | 2 drops | 3 drops |
| | | (0.44 wt. %) | (0.88 wt. %) | (1.32 wt. %) |
| Weight loss during | 0.046 | 0.004 | 0.000 | −0.002 |
| formation (g) | | | | |
| Capacity (mAh/g) | 244.55 | 245.88 | 249.73 | 250.38 |
| Internal Resistance | 17.43 | 18.00 | 17.43 | 17.53 |
| (mΩ) | | | | |
| Charge Retention | 21.38% | 25.79% | 29.41% | 35.00% |
| 60° C., 28 days | | | | |
| Resistance Drift | 37.16% | 31.02% | 26.06% | 28.58% |
| 60° C., 28 days | | | | |
| Capacity | 6.02% | 6.83% | 6.21% | 4.27% |
| Degradation after | | | | |
| 300 cycles | | | | |
| Internal Resistance | 91.6 | 89.9 | 105.5 | 75.0 |
| after 300 Cycle | | | | |
| (mΩ) | | | | |
| Mid-point Voltage | 1.205 | 1.207 | 1.211 | 1.223 |
| after 300 Cycle | | | | |
| (V) | | | | |

TABLE 2
Sealed cell performance comparing control (A1) and cells with
H₂O₂ added (A2-A4) from AB5 alloy.

| | B1 | B2 | B3 | B4 | B5 |
|---|---|---|---|---|---|
| H₂O₂ amount | 0 | 1 drop | 2 drops | 3 drops | 4 drops |
| | | (0.44 wt. | (0.88 wt. | (1.32 wt. | (1.76 wt. |
| | | %) | %) | %) | %) |
| Weight loss | 0.042 | −0.008 | −0.007 | 0.001 | 0.002 |
| during | | | | | |
| formation (g) | | | | | |
| Capacity | 247.96 | 248.08 | 253.02 | 254.74 | 247.89 |
| (mAh/g) | | | | | |
| Internal | 16.46 | 17.43 | 17.43 | 16.93 | 16.11 |
| Resistance | | | | | |
| (mΩ) | | | | | |
| Charge | 22.25% | 24.52% | 29.03% | 29.17% | 22.31% |
| Retention | | | | | |
| 60° C., 28 days | | | | | |
| Resistance | 27.21% | 22.80% | 19.88% | 15.41% | 47.01% |
| Drift 60° C., | | | | | |
| 28 days | | | | | |
| Capacity | 26.03% | 23.04% | 28.10% | 26.77% | 32.57% |
| Degradation | | | | | |
| after 300 cycles | | | | | |
| Internal | 331 | 365 | 347 | 346 | 439 |
| Resistance after | | | | | |
| 300 Cycle | | | | | |
| (mΩ) | | | | | |
| Mid-point | 1.198 | 1.194 | 1.217 | 1.199 | 1.144 |
| Voltage after | | | | | |
| 200 Cycle (V) | | | | | |

The invention claimed is:

1. A method of improving the properties of a rechargeable nickel metal hydride battery by adding certain amount of oxidation agent in the alkaline electrolyte right before the closing of a sealed battery.

2. Method according to claim 1 wherein the rechargeable nickel metal hydride battery may use misch metal based AB5 alloy as the negative electrode active material.

3. Method according to claim 1 wherein the rechargeable nickel metal hydride battery may use magnesium misch metal based ABₓ alloy as the negative electrode active material, where x is between 3 and 4.

4. Method according to claim 1 wherein the oxidation agent is hydrogen peroxide.

5. Method according to claim 1 wherein the amount of the oxidation agent is from 0.1 to 5 wt. %of the electrolyte.

6. Method according to claim 4 wherein the amount of the oxidation agent is from 0.2 to 1.5 wt. % of the electrolyte.

7. Method according to claim 3 wherein the amount of the neodymium is from 80 to 100 wt. % of the mish metal

8. Method according to claim 3 wherein the amount of the cobalt and manganese is from 0 to 1 wt. % of the ABₓ alloy.
